(19) United States
(12) Patent Application Publication
(10) Pub. No.: US 2008/0095674 A1
(43) Pub. Date: Apr. 24, 2008

(54) Rotary Reactor for Nixtamalization

(76) Inventor: Pablo A. Meouchi Saade, Mexico (MX)

Correspondence Address: CONNOLLY BOVE LODGE & HUTZ LLP, 1875 EYE STREET, N.W., SUITE 1100, WASHINGTON, DC, 20036, US

(21) Appl. No.: 10/590,294

(22) PCT Filed: Jan. 21, 2005
(86) PCT No.: PCT/MX05/00006

§ 371 Date: Aug. 14, 2007

(30) Foreign Application Priority Data
Feb. 23, 2004 (MX) PA/A/2004/001693

(51) Int. Cl. B01J 19/28; B01F 9/06; B02B 1/08

(52) U.S. Cl. 422/105; 422/119; 422/189; 422/209

(57) ABSTRACT

The invention relates to the dough and pancake industry, and all new industries wherein a product undergoes nixtamilization. The invention more particularly relates to a rotary reactor for nixtamalization, having a better capacity for homogenization of the reagents in both the process and product. The advantages of reactors included in the invention when compared to prior art is that they enable a higher degree of homogenization of the trinomial water, lime and product to be nixtamalized and make it possible to control the homogenization operation of the trinomial without damaging the soft grains and to achieve homogenization of the temperature throughout the entire mass of the product. Structurally speaking, the reactors according to the present invention are characterized in that they are made up of a center chamber surrounded by a series of jackets, including one longitudinal end at a given height, and another longitudinal opposite end at a lower height, wherein the longitudinal line of the reactor forms an angle which is selected between 15° and 30° in relation to the horizontal.

### FIELD OF THE INVENTION

The present invention is related to the dough and tortilla industry, and any other new industry in which nixtamalization of any product is required, more specifically it is related to a rotary reactor for nixtamalization, with a better homogenization capacity of the reagents in both the process and the product.

### BACKGROUND OF THE INVENTION

The process of nixtamalization of corn is an ancient one in present day Mexico, Guatemala and some other Central American countries where there were Mayan settlements. These processes over time, as many other daily activities in most Pre Hispanic tribes, acquired religious connotations.

As is well known, the nixtamalization process is alkaline cooking of any product. That is to say, it consists of cooking a product in a basic aqueous medium.

On occasion, the source of alkali for nixtamalization was the bones of a human, ex-family member, an outstanding warrior who was renown for said activity, etc.

Even today, the general source of alkali is a calcium hydroxide or oxide.

Given that, on the one hand, calcium passed little by little into the inner layers of the grain of corn during the nixtamalization process, and on the other hand, the OH ion reacted with some membrane of the grain, or with the impurities of the same, these circumstances made for variations in the concentration of sodium hydroxide and thus of the pH of the aqueous medium in which the product was being cooked.

On the other hand, it is a known fact that the solubility of calcium hydroxide in water is very low and in order to maintain the proper concentration it is necessary to add to the medium a quantity which over saturates the solution with the inherent problems to the precipitations of said chemical composition.

In home style processes this did not originate more than the necessity to periodically mix the trinomial of water, lime and corn kernels.

This became an important problem when nixtamalization of large quantities of corn was taking place in mills or tortilla processors because the strength required to periodically mix the aforementioned trinomial called for an important human effort.

This last problem was resolved with the development of a rotating reactor described in the Mexican patent 191283, by the same inventor whose invention is described within the present description.

The integral description of said patent is added for consultation to the present invention.

With the use of the reactor of said Mexican patent 191283, it was observed that constant homogenization of the trinomial was not achieved in its optimum form; therefore in the present invention some structural characteristics of said reactor are added in order to better its homogenization function.

The state of the arte reactor, although allowing a certain degree of agitation, does not permit an important change in position of the elements of the trinomial.

Through the analysis of the performance having to do with the temperature prevailing at the different levels in height of the trinomial components, it was observed by way of heat transfer phenomena, that the temperature in the center of the heart of the trinomial was lower than the temperature reached in the layers of the trinomial which were in contact with the walls of the reactor.

The former is true in spite of the phenomena of transferal of heat by natural convection.

Then the state of the art reactor, while permitting a degree of homogenization with relationship to the concentration of lime, does not allow for homogenization of temperature in the layers at different heights and positions in general.

Another aspect not divulged in the Mexican patent 191283 was the way in which the nixtamalized material was to be removed. The divulged rotary reactor consists of a certain degree of inclination, to allow for complete emptying of the same once the process of nixtamalization of the product has been carried out in an optimal form.

The way in which the trinomial is kept within the reactor during the process of nixtamalization is not mentioned, nor is the way in which later the extraction of the nixtamalized product is carried out at the end of the process. In order to achieve these two functions, it is necessary to be able to cover with a seal the medium employed when the process of nixtamalization is going on and also allow the processed material to be removed.

The suitable inclination of the reactor was not shown either for the correct functioning during the nixtamalization process as well as during the emptying process.

On the other hand, given that some corn has a structure that is softer than others, it is necessary to control the unit operation of agitation during the operation of nixtamalization in order to avoid harming the grain, a characteristic of control of agitation which the reactor as described in the Mexican patent MX 191283 does not provide.

It is now known that the hardness and softness of the grain depends on the percentage of horn endosperm with regard to soft endosperm in the grain of corn. All grains have both types of endosperm, however in some one predominates more than the other and this determines the global hardness of corn.

It is also know that the horn endosperm is made up of cells in whose interior there is a protein core thicker than the protein cores of the cells of floury endosperms, even though the cellular walls of floury endosperms are thicker than the cellular walls of cells of horn endosperms.

The state of the art rotating reactor consists of a heating system which is made up of two jackets, an exterior jacket in which hot burnt gases circulate and an intermediate jacket where thermal oil is. The burnt gasses cede part of their appreciable heat to heat the thermal oil in the neighboring jacket and said thermal oil in turn heats the components contained in the nixtamalization chamber.

This heating system has serious problems with respect to the coefficient of heat transmission and with respect to the thermal inertia of the oil. Making a simile, it is equivalent to the use of a frying pan made of thick metal which takes a long time to heat up and a long time to cool off.

The exterior jacket, in rotary nixtamalization reactors, which is the jacket that contains the burnt gases, may control the temperature by means of the amount of fuel which is burned.

The oil jacket will have a temperature which will depend as much on the prevailing temperature in the inside of the internal chamber, as on the transfer rate of heat from the oil jacket, the temperature of the burnt gases in the outer jacket and the transfer rate of heat from the exterior jacket to the oil jacket.

In the normal functioning process of the reactor, the exterior jacket is preheated with hot air and the oil jacket and the nixtamalization chamber are preheated as a result of the transmission of heat from the exterior jacket and the transmission of heat from the oil jacket to the nixtamalization chamber.

When the temperature of these jackets reaches the desired temperature level, the elements of nixtamalization are fed in, that is to say, the grain, the water and the lime.

Depending on the temperature of these elements at the time of feeding and the temperature of the chamber, a certain amount of heat is lost due to the effect of a certain amount of evaporation of the water fed in (latent heat of evaporation) and due to the effect of the rise in temperature of the trinomial water-lime-corn.

The energy required for these processes is absorbed from the oil of the surrounding jacket, causing the temperature of the oil to descend. The speed of the rise in temperature of the elements of nixtamalization will depend on how fast the oil cedes the required heat. Since appreciable nixtamalization takes place beginning at 72° C., in this stage there exist changes in the corn which must be taken into account for the final results.

Then, establishing a time and temperature for nixtamalization is made extremely difficult by the inertia which the oil has to heat up and cool off.

On the other hand, it has been seen that there are three steps in the normal nixtamalization processes, the first step is that which begins when the trinomial corn-water-lime is fed in up to the moment when the maximum fixed temperature for nixtamalization is reached, the following step consists of the time that this maximum temperature is maintained and the third goes from the maximum temperature to the emptying of the nixtamalized grain through the resting period. It has been estimated that in order for correct nixtamalization to take place, the various steps should each consist of one third of the total time established for nixtamalization.

A structure which resolves the aforementioned deficiencies in the state of the art reactor would make for important advances in nixtamalization operation.

In the state of the art reactors it is also difficult to control the temperatures in order to achieve this profile of heating, conservation and cooling of the trinomial corn-water-lime; it should be noted that through the use of state of art rotary reactors, the trinomial corn-water-lime, in the end consists of one single product, nixtamalized corn with a certain degree of water and lime.

### OBJECTIVES OF THE INVENTION

One of the objectives of the present invention is to achieve a reactor structure for nixtamalization which improves the degree of homogenization of the trinomial water, lime and the product to be nixtamalized.

Another of the objectives of the present invention is to make possible a nixtamalization reactor which controls the homogenization process of the trinomial without damaging the grain with a higher percentage of soft endosperm in relation to horn endosperm as well as those with more abundant horn endosperm in relation to soft endosperm.

Still another objective of the present invention is to provide a nixtamalization reactor which homogenizes, besides the concentration of lime in the heart of the trinomial, the temperature in any part of the trinomial dough.

Still another objective is to improve the heating system of the nixtamalization reactors in order to achieve temperature control of the content of the nixtamalization chamber.

Still another objective of the present invention is to achieve control of nixtamalization times in the three normal steps in the nixtamalization process.

Other objectives and advantages of the present invention will become apparent through the study of the following description and drawings which accompany it with strictly illustrative and not limiting purposes.

### BRIEF DESCRIPTION OF THE INVENTION

Briefly, on one hand the present invention will be reflected in reactors with a given inclination, with dragging means in the nixtamalization chamber and in the heating system of the reactor.

With relation to the inclination, it was proven that with greater inclinations the capacity of the reactor was greatly reduced, and if the inclination was too small the unloading process was incomplete.

This inclination is combined with the conformation of the reactor, including the position of the unloading means, in order to achieve optimum emptying and load capacity.

Likewise, on the other hand, reactors which reflect the teachings of the present invention have means which improve the operation of homogenization of the trinomial water, lime and the product to be nixtamalized and means to control agitation, making it more or less intense, depending on the hardness of the product to be nixtamalized.

One of the means used to improve the homogenization of the trinomial consists of providing the reactor with means which assure that at a certain time the water, lime and the product are all in the lower levels of the reactor, and at a subsequent time they are displaced to a higher level.

One embodiment which achieves the preceding provides the reactor with dragging means for the water, lime and product. This embodiment may adopt various means, generally consisting of fixed bands on the inner face of the reactor to achieve the dragging. These bands are affixed to the inner wall at different angles in relation to the secant of the cylindrical wall. These bands may be straight, and placed longitudinally in the reactor, separated a predetermined distance from one another.

The angle at which they are affixed to the inner face of the innermost wall of the reactor, together with the direction in which the reactor rotates, will determine the height at which the trinomial will fall. If the angle of the band in relation to the internal face is acute on the side of the rotation, the material will take longer to fall than if the angle of the band in relation to the internal face is obtuse. A right angle is appropriate and the speed with which the grain will fall depends on the angle of the band in a resting position.

Besides the angle, the height of these bands will determine the amount of the trinomial which is dragged. The higher the band, the more material will be dragged.

Also, the reactors which are covered in the teachings of the present invention contain a frequency variator connected to the motor which provides the spin of the reactor. Thus the speed of the spinning of the reactor is controlled, in order to adapt it to the hardness of the corn which is to be nixtamalized.

The number of dragging bands and the height of these was studied in nixtamalization chambers. The change in position of various segments of the bed of grain to be nixtamalized was taken as a response variable to measure the degree of mixing and the change in position in the height and on the other hand the amount of water, lime and corn dragged in each rotation of the reactor.

What seems logical was proved true. The more dragging bands used and the higher the height of the bands, the greater the volume of material dragged, however, it was found that, depending on the height of the bands, at the same angle in relation to the internal face of the reaction chamber, there is a different performance in relation to the height at which 50% of the dragged material falls. When the number of blades is excessive and the height is too elevated, an important amount of dragged grain and water never reaches the lowest level of the reactor because the grain would empty into a relatively close dragging band.

In the performance of a reactor where the water added is such that all the water with lime is absorbed by the grain, it is important that the design allows for all the grain to have the same probability of being in contact with said water with lime in order to obtain homogenous nixtamalization. As the number of dragging bands increases and these are higher, and since in its trajectory the dragged water, having a smaller resting angle, will fall before the last grain is dragged, thus the time this last dragged grain will be immersed in the water-lime suspension will depend on the moment at which this last grain falls to the bottom of the reactor.

The simple fact of providing at least one dragging band in the reactor improves the mixing of the trinomial water-lime-corn. However, according to the Law of Diminishing Yield, there exist a maximum number of blades which may be provided to the reactor.

The height of the bands has similar performance. One centimeter of height in the bands reflects better performance, although minimum, in the homogenization of the trinomial. However, it was determined that a height of over 40 cm, besides providing a negative improvement in homogenization, made important mechanical resistance necessary in homogenization in the means for affixing the bands to the internal face of the reactor as well as the band itself, implying a change in material, a thermal treatment of said material or a greater thickness, with the corresponding mechanical load of the distinct affixing elements of the reactor.

Giving the dragging bands a configuration called butterfly wing was an improvement in the dragging bands. This means that two thirds way up the band a fold is formed so that the last third of the dragging band forms an angle equal to 120° in relation to the straight part.

It was determined that the number of dragging bands which could work in the reactor which is the object of the present invention is between 1 and 12.

As far as the height of the bands goes, this may vary from 1 cm to 40 cm.

As far as the heating system is concerned, the number of jackets was modified, leaving only 1 jacket. This jacket is a jacket which contains a series of volutes to heat the nixtamalization chamber, but it may also contain in an alternate layout volutes for cooling.

An analysis of state of the art rotary reactors shows that with a wider ΔT there is a greater heat loss and due to the nature of heating in situ of the oil to a certain temperature, the temperature of the combustion gases o hot air which reaches the jacket should be greater than the temperature which is sought for the heart of the trinomial water-corn-lime.

Also, with this state of the art structure it is difficult to control the temperature, requiring large amounts of gas to heat the oil and although the reactor is designed to carry out the nixtamalization process, it is not designed to carry out the transferal of heat from the jacket of hot gasses to the oil jacket.

Likewise, the external surface of the hot gases is overly large, permitting the heat to escape through radiation and convection. The proportion of exposed surface chamber volume is too high.

Thus, heating the oil to the required temperature takes place in an oil heater; the oil is kept in constant circulation by means of a pump which propels the hot oil from the heater to the reactor and sends it back to the heater to complete the entire cycle.

In this description the working fluid is thermal oil, but the same application can be made with other fluids.

The working fluid may be water vapor, hot burnt gases and thermal oil. The source of heat could be burnt fuel or electrical resistance.

We propose a rotary nixtamalization reactor with only one jacket or with two partially joined jackets. These jackets may contain the working fluid described above.

In order to improve the transfer of heat, the nixtamalization reactor, in the case of a single jacket, on the inside may have a series of volutes through which the working fluids flow. These volutes are formed by bands placed helicoidally, or by two series of volutes interspersed.

To heat the working fluid burnt gases or thermal oil or even vapor may be used. To cool, room temperature water is used.

In one of the embodiments, the working fluid consists of hot gases which originate from combustion, and are introduced into the sole jacket or the partially joined jackets.

In order to better understand the features of the invention the following drawings accompany the present description as an integral part of the later, in illustrative but not limiting character.

### BRIEF DESCRIPTION OF THE DRAWINGS

FIG. 1 shows a schematic longitudinal section of the reactor which is the object of the present invention, showing the angle of inclination of said reactor in relation to the horizontal.

FIG. 2 shows a cross section of the reactor with the bands which drag the material, affixed at a 90 degree angle.

FIG. 3 shows a schematic cross section of the reactor illustrated in FIG. 2 with the bands affixed in an inclined position.

FIG. 4 shows the scheme of the electrical connection from the motor which moves the reactor, to the frequency variator.

FIG. 5 shows the details of the hatch for emptying in the embodiment which consists of heating volutes.

FIG. 6 shows in conventional perspective the reactor in the embodiment which consists of heating volutes.

FIG. 7 shows in conventional perspective the reactor of the present invention in the embodiment in which cooling volutes are also included.

FIG. 8 shows a cross section of the reactor showing the dragging bands in the embodiment in which they are straight.

FIG. 9 shows a cross section of the reactor in which gull wing dragging bands have been installed.

FIG. 10 shows the minimum changes required in the state of the art rotary reactor for use with one sole working fluid.

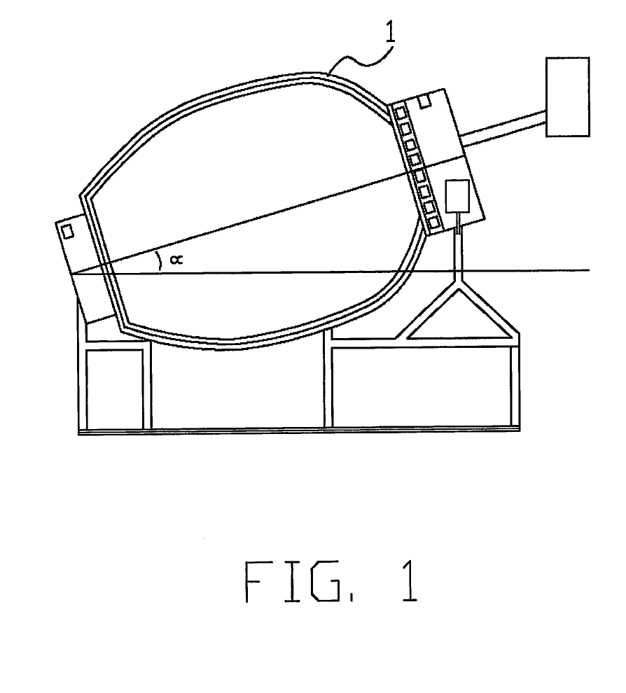

In order to better understand the invention, a detailed description shall be made of some of the embodiments of the later shown in the drawings annexed to the present description with illustrative but not limiting means.

### DETAILED DESCRIPTION OF THE INVENTION

The details which are characteristics of the reactor are the teachings of the present invention and are clearly shown in the following description and in the illustrative drawings which are annexed, the same reference signs showing the same parts.

With reference to FIG. I which shows a schematic longitudinal section of the reactor which is the object of the present invention, marking angle α of an inclination of said reactor in relation to the horizontal, we shall indicate that this angle varies between 15 and 30°.

If this inclination is less than the smallest extreme of this interval, the emptying of the nixtamalized material is very difficult, a remnant of the material always remaining in the reactor.

With an inclination greater than 30° the capacity of the reactor, which is open to air, is reduced to avoid material from spilling since the reactor is open on the ends.

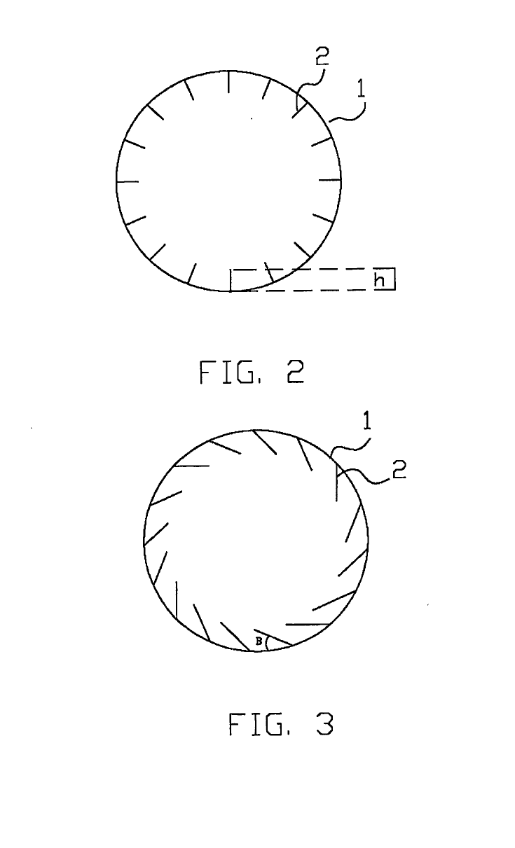

FIG. 2 shows a cross section of the reactor with the bands which drag the material, affixed at an angle of 90 degrees. The height h of the band is variable and depends on the amount of material which is to be dragged.

The larger the amount of material to be dragged, more vigorous is the agitation and the reaction is better, however if the product to be nixtamalized is soft, this agitation may spoil it, making the dough difficult to handle, due to gelatinized starch.

It was proved that a height of the band between 20 and 30 centimeters allowed for handling a variety of types of corn, controlling the speed of rotation of the reactor.

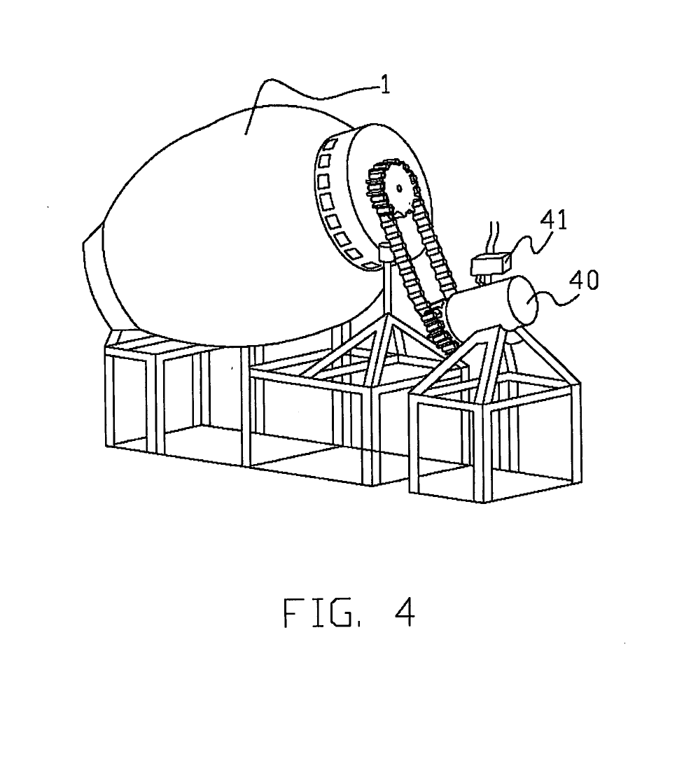

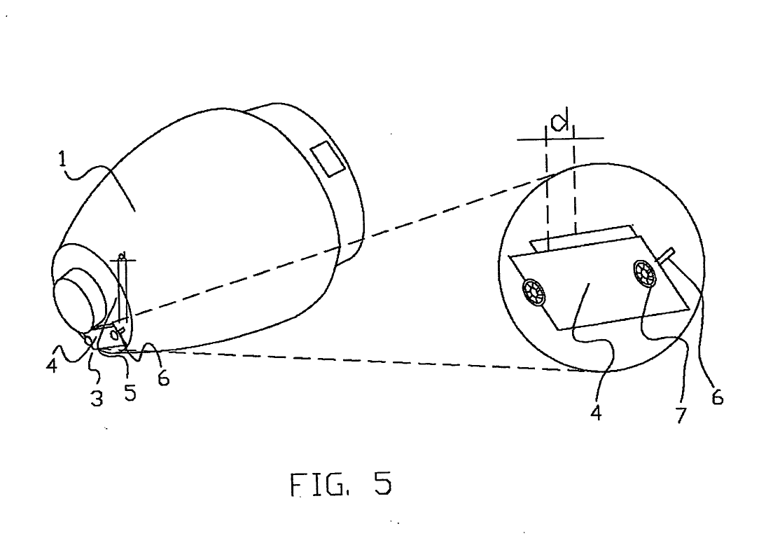

FIG. 3 shows a schematic cross section of the reactor illustrated in FIG. 2 with the bands affixed on an incline. Inclination β of the band in relation to the internal face of the reactor allows for determining the height at which the product will fall from the rotation. The more acute the angle on the rotating side, the higher the material is transported before falling again.

With a more obtuse angle on the rotating side the grain begins to slide more quickly, and when this dragger reaches a little over one fourth of a turn, the entire product has already slid down completely.

It was proven that the appropriate inclination of the dragging bands 2 was between 80 and 100°. Optimally for most types of corn, the angle is 90°.

FIG. 4 shows the scheme of the electrical connection of the motor 40 which moves reactor 1 to the frequency variator 41.

With this frequency variator the speed control of the rotation of the reactor is obtained, making the agitation more or less vigorous, depending on the conditions required for the type of material.

FIG. 5 shows the detail of the hatch for the controlled emptying of the nixtamalized material. This hatch is located in the lower longitudinal end of the reactor, at its lowest end.

It consists of a panel with affixing means to be sealed to the periphery of a window of the reactor. These means are designed to allow for regulating the distance between the panel and the external wall of the reactor. By means of this control the amount of already nixtamalized material can be controlled as it passes to the other steps in the process. The farther the panel is separated from the outer wall of the reactor, the more material will pass through in each step of rotation in which the exit is in the lower position.

In this embodiment, the seal and control of separation between the panel and the reactor is achieved by means of a pair of threaded dowels and corresponding butterfly nuts or nuts with flywheels, which when turned one way close and seal and when turned the other way separate the panel to a degree, attaining variable openings.

Since the completely nixtamalized material is material in which all the water and lime have been absorbed, at the time it is unloaded there is no problem of dripping. The material simply slides due to the effect of gravity through the corresponding opening between the panel of emptying control which is the same panel which also seals during the nixtamalization process.

The operation of the reactor then consists of receiving the amount of material to be nixtamalized together with water and lime. Depending on the moisture content and hardness of the corn are the amount of water and lime to be added. Also using these variables, the time, temperature and rotation speed are determined. Said speed is controlled by means of the frequency variator of the motor of the rotating reactor. When the nixtamalization time is over the exit of the reactor opens, the panel which controls this exit is pulled open and in each interval of the rotation when the opening is lower than or at the level of the upper level of the nixtamalized material a certain amount of the material falls out, these dumpings being repeated until the reactor is completely empty.

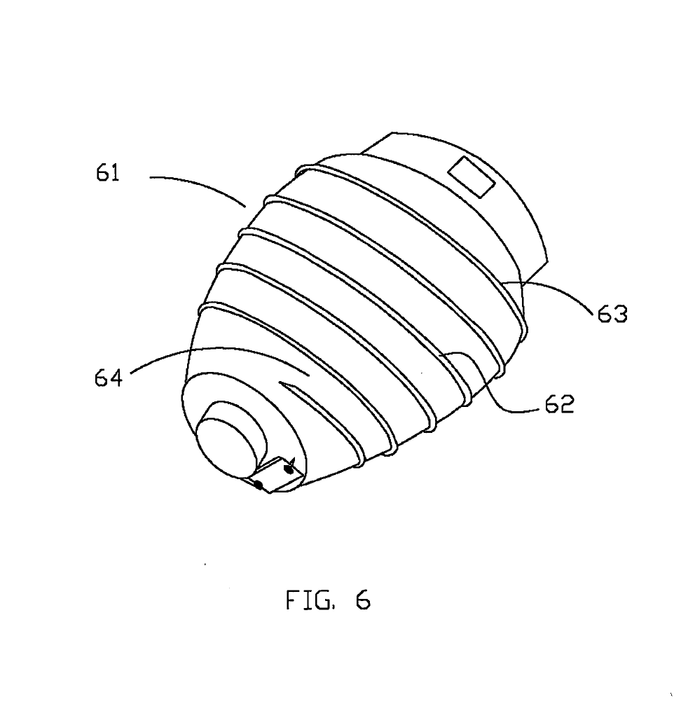

With reference to FIG. 6, this shows a conventional perspective of the reactor in the embodiment consisting of heating volutes. In this figure the external covering which makes up the continuous form jacket has been omitted.

The body of reactor 61 consists on its exterior face of a volute 62 which on the inside will conduct the working fluid. The working fluid will enter through the end of volute 63 and will exit through the opposite end 64.

Besides attaining the circulation of air with longer lodging time, at the same time displacement which allows for a better transfer of sensitive heat contained in the working fluid (referring to burnt gases and thermal oil) and transfer of latent heat and sensitive heat in the case of vapor are obtained.

The later is true due to the fact that the regime of fluid flow is a turbulent flow which diminishes the phenomena of external layer in connection with the interior surface of the ducts.

Furthermore, it was determined that although any type of burner could achieve comparative advantages in relation to state of the arte reactors, the most recommendable burners are low pressure modulating burners.

We have, then, in one of the embodiments, a burner which provides sensible heat in order to reach the required temperatures, during a predetermined time, at the entrance of the volutes, generally in the lower part of the reactor.

In the case that water vapor is used as the working fluid, this is generally fid in through the top part, the transmission coefficient for heat being much higher than in the case of burnt gases.

In the case that hot gases are used, two possibilities exist; the first is that of heating the oil in a Dow Ther and later having it circulate through the volute. By controlling the mass flow and the temperature of the thermal oil it is possible to control the temperature of the nixtamalized corn for a precise nixtamalization process.

The other possibility consists of heating the thermal oil by means of electric resistances, allowing temperature control by electromechanical means.

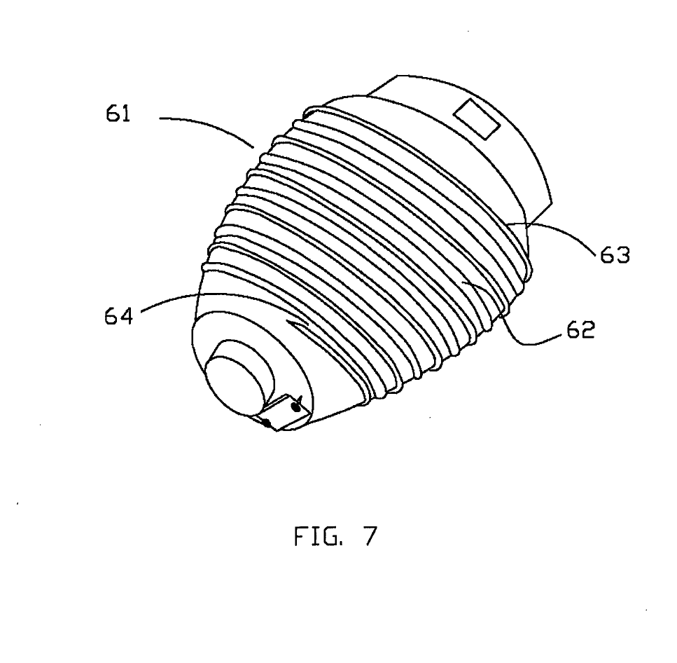

In order to achieve the cooling of the reactor at the end of the nixtamalization process and reach the resting temperature, an adaptation is made to the reactor as can be seen in FIG. 7, where in a conventional perspective the reactor of the present invention in an embodiment in which cooling volutes are included is illustrated.

Thus, in this embodiment, the hot working fluid will be fed in by means of one of the volutes and cold water will be introduced through the other volute, without adding hot gases through the heating volute, when it is necessary to reduce the temperature within the nixtamalization reactor.

In the embodiment of reactor illustrated in FIG. 6 it is possible to achieve cooling by reducing or completely putting out the flame of the burner and by means of some mechanism introducing room temperature air through the only volute.

Although not illustrated, it was determined as a result of various tests, that it is possible to use a reactor with the characteristics of the state of the art with two jackets, making some window-like perforations in the common wall of the outer jacket in order to achieve the circulation of working fluid in the interior of the interior jacket. The working fluid would enter the external chamber and through the windows made in the common wall.

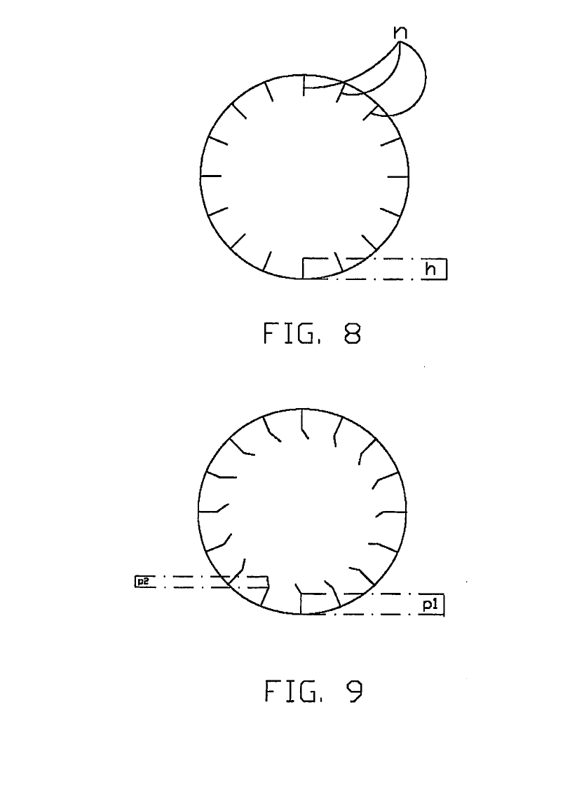

In relation to another aspect of the present invention, FIG. 8 shows a cross section of the reactor showing the dragging bands in the embodiment in which said bands are straight. The height (h) of the band is between 1 and 40 cm, and the number of said bands (n) is between 1 and 12.

FIG. 9 shows a cross section of a reactor in which gull wing dragging bands have been installed. In these bands there is a first cant p1 and a second cant p2, the second cant being ⅓ of the height of the whole band.

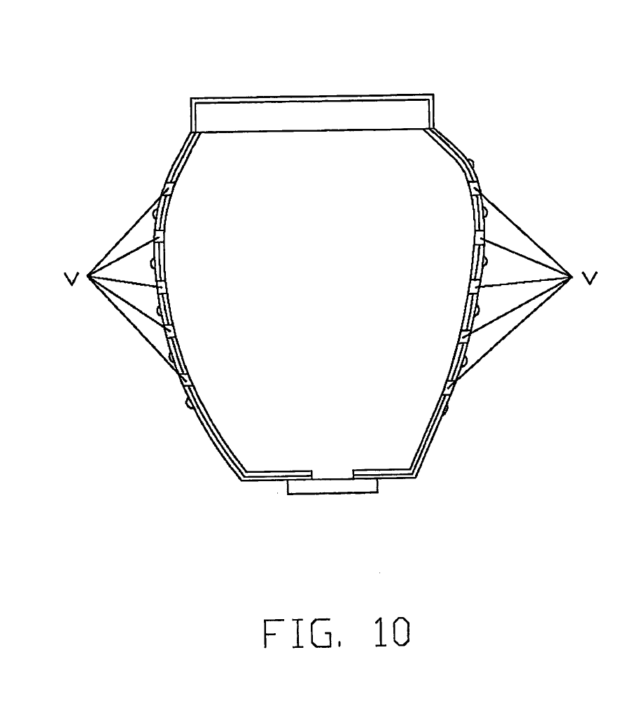

FIG. 10 shows the minimal changes required for the state of the art rotary reactor to be used with one single working fluid.

These modifications consist simply of making some windows V in the common wall of the external jacket and the internal jacket.

The invention has been sufficiently described so that any person with average knowledge in the field may reproduce and obtain the results we mention in the present invention. However, any person, capable in the field of the technique of the present invention is able to make modifications not described in the present application, however, if for the application of these modifications in the determined structure or in the manufacturing process of the later, the material laid claim to in the following claims is required, said structures should be considered within the scope of the invention.

1. Rotary reactor for nixtamalization, of the type formed by a central chamber and a series of jackets surrounding it, characterized by consisting of a longitudinal end at a given height, and another longitudinal opposite end at a lower height, wherein the longitudinal line of the reactor forms an angle which is selected between 15° and 30° in relation to the horizontal.

2. Rotary reactor for nixtamalization as claimed in claim 1, characterized by consisting of inside the central chamber, affixed to the internal face, a series of draggers that consist of parallel bands, placed tangentially to the interior face of the central chamber of the reactor.

3. Rotary reactor for nixtamalization as claimed in claim 2, characterized by the band forming an angle in relation to the internal face of the central chamber, which is selected from between 80 and 100°.

4. Rotary reactor for nixtamalization as claimed in claim 3, characterized by the band forming an angle in relation to the internal face of the central chamber, which is equal to 90°.

5. Rotary reactor for nixtamalization as claimed in claim 2, characterized by la band having height selected between the interval formed between 20 and 30 cm.

6. Rotary reactor for nixtamalization as claimed in claim 5, characterized by the band having a height of 25 cm.

7. Rotary reactor for nixtamalization as claimed in claim 1, characterized by the reactor consisting of a means of control for the exit of nixtamalized material, which consists of an opening in the longitudinal end of the reactor which is at the lower height in relation to the height of the opposite end, a panel of larger perimeter than the opening, but with a geometric configuration which may occlude said opening, and some affixing means for this reactor panel, corresponding to the position of the opening, said affixing means having the ability to control the degree of separation between the panel and the reactor in order to allow the exiting of more or less nixtamalized material.

8. Rotary reactor for nixtamalization as claimed in claim 7, characterized by said affixing means being formed by a pair of threaded dowels located on the opposite ends of the panel and some bodies with internal threads for screwing said dowels, displacing said panel towards the reactor or separating it from the reactor.

9. Rotary reactor for nixtamalization as claimed in claim 1, characterized by said affixing means being formed by a pair of threaded dowels placed on opposite ends and some bodies with internal threads for screwing said dowels, displacing said panel towards the reactor or separating it from the reactor.

10. Rotary reactor for nixtamalization, the reactor characterized by on the internal face of the wall which divides the central chamber from the intermediate chamber, dragging bands are placed, in number between 1 and 12, with a height of band between 1 and 40 cm.

11. Rotary reactor for nixtamalization as described in claim 10, characterized by said bands presenting la configuration of a gull wing.

12. Rotary reactor for nixtamalization as described in claim 10, characterized by having just one jacket wherein working fluid is fed for heating the nixtamalization chamber; the working fluid is chosen between vapor, burnt gases and thermal oil and the source of heat is chosen between the burning of a fuel and the passage of electric energy through resistances.

13. Rotary reactor for nixtamalization as described in claim 12, characterized by the working fluid being burnt gas.

14. Rotary reactor for nixtamalization as described in claim 10, characterized by consisting of an external volute formed by a band which is united by means of a helicoidal cant to the external surface of the nixtamalization chamber, in order to allow a longer flow of the working fluid thus obtaining better thermal exchange.

15. Rotary reactor for nixtamalization as described in claim 14, characterized by besides a front volute, there is a second intermediate volute with the same development as the first; said second volute is formed in order to allow the passage of a second working fluid, at a low temperature in relation to the first working fluid.

16. Rotary reactor for nixtamalization as described in claim 15, characterized by also said second volute being formed by a half round which is attached to the intermediate space of the first volute and follows the same rotation.

17. Rotary reactor for nixtamalization as described in claim 10, characterized by consisting of two jackets communicated by means of a series of windows made in the common wall of said jackets.

18. Rotary reactor for nixtamalization as claimed in claim 3, characterized by la band having height selected between the interval formed between 20 and 30 cm.

19. Rotary reactor for nixtamalization as claimed in claim 4, characterized by la band having height selected between the interval formed between 20 and 30 cm.

20. Rotary reactor for nixtamalization as claimed in claim 2, characterized by the reactor consisting of a means of control for the exit of nixtamalized material, which consists of an opening in the longitudinal end of the reactor which is at the lower height in relation to the height of the opposite end, a panel of larger perimeter than the opening, but with a geometric configuration which may occlude said opening, and some affixing means for this reactor panel, corresponding to the position of the opening, said affixing means having the ability to control the degree of separation between the panel and the reactor in order to allow the exiting of more or less nixtamalized material.
